(19) United States
(12) Patent Application Publication
(10) Pub. No.: US 2013/0185371 A1
(43) Pub. Date: Jul. 18, 2013

(54) MESSAGE TRANSMISSION SYSTEM AND METHOD USING LOCATION BASED SERVICE

(71) Applicant: Jong Ok Ko, Seoul (KR)

(72) Inventor: Jong Ok Ko, Seoul (KR)

(73) Assignee: FOBIKR CO., LTD., Incheon (KR)

(21) Appl. No.: 13/876,955

(22) PCT Filed: Sep. 28, 2011
(86) PCT No.: PCT/KR2011/007126

§ 371 Date: Mar. 29, 2013

(30) Foreign Application Priority Data
Sep. 30, 2010 (KR) 10-2010-0094966

(51) Int. Cl. H04L 12/24

(52) U.S. Cl. CPC H04L 41/026
USPC 709/206

(57) ABSTRACT

A location-based message transmission and reception system and method comprises a terminal configured to transmit location information of a specified area and a message made by a user to a server; a mobile terminal configured to include a message receiving application to receive a message transmitted to a specified area and to transmit its location information to the server in response to executing the message receiving application and output a message received from the server on a display; and the server configured to store the message and location information of the specified area received from the terminal, to confirm, based on the location information received from the mobile terminal, whether the mobile terminal is located within a radius from a location in an area specified by the location information received from the terminal, and to transmit the message received from the terminal to the mobile terminal.

### TECHNICAL FIELD

The present invention relates to a location-based message transmission and reception system and method, and more particularly, to a technique for specifying an area and transmitting a message to mobile terminals located in the specific area.

### BACKGROUND ART

In general, short message service (SMS) refers to a service to transmit text messages of a limited length from a computer to mobile terminals over the Internet or between the mobile terminals regardless of the connection state of recipient terminals. Due to the expanding use of SMS, from personal individual use to business use, the usage rate of the SMS has been explosively increasing. In other words, the recent use of SMS goes beyond a simple message transmission between individuals, and varies from group-to-group message transmission, scheduled transmission, notification of receipt of an email, personal information management, notification of stock information, notification of product information, notification of financial information, and the like.

However, such SMS only transmits a message to a specified recipient, and cannot deliver the message to unspecified recipients located in an arbitrary area.

### DISCLOSURE OF INVENTION

### Technical Problem

The present invention provides a message transmission and reception system and method for transmitting a message to unspecified recipients located in an arbitrary area and allowing the unspecified recipients at the area to receive the message.

### Solution to Problem

The present invention provides a location-based message transmission and reception system including: a terminal configured to transmit location information of a specified area and a message made by a user to a server; a mobile terminal configured to include a message receiving application to receive a message transmitted to a specified area and to transmit its location information to the server in response to executing the message receiving application and output a message received from the server on a display; and the server configured to store the message and location information of the specified area received from the terminal, to confirm, based on the location information received from the mobile terminal, whether the mobile terminal is located within a radius from a location in an area specified by the location information received from the terminal, and to transmit the message received from the terminal to the mobile terminal.

The terminal, the mobile terminal, and the server may communicate with one another via a data network of a mobile communication network or a wireless Internet.

The server may charge a message transmission fee to the user of the terminal according to a distance over which the message received from the terminal is transmitted and valid time of the message.

The server may store a message receiving application programming interface (API) generated from the message receiving application.

The message receiving API may be provided to be executed in a plurality of applications running on the mobile terminal.

The server may further store developer information of developers of the respective applications equipped with the message receiving API.

The server may distribute profit generated from the message transmission fee charged to the user of the terminal to the developers of the respective applications.

The present invention provides a location-based message transmission and reception method including: transmitting, from a terminal, location information of a specified area and a message made by a user of the terminal to a server; storing, at the server, the message and location information of the specified area received from the terminal; executing, at a mobile terminal, a message receiving application to receive a message transmitted to a specified area and transmitting location information of the mobile terminal to the server; confirming, at the server, based on the location information received from the mobile terminal, whether the mobile terminal is located within a radius from a location in an area specified by the location information received from the terminal, and transmitting the message received from the terminal to the mobile terminal; and outputting, at the mobile terminal, the message received from the server on a display of the mobile terminal.

The location-based message transmission and reception method may further include charging, at the server, a message transmission fee to the user of the terminal according to a distance over which the message received from the terminal is transmitted and valid time of the message.

The location-based message transmission and reception method may further include distributing, at the server, profit generated from the message transmission fee charged to the user of the terminal to the developers of the respective applications.

Additional features of the invention will be set forth in the description which follows, and in part will be apparent from the description, or may be learned by practice of the invention.

### Advantageous Effects of Invention

According to a location-based message transmission and reception system and method in accordance with exemplary embodiments of the invention, a terminal transmits location information of a specified area and a message made by a user to a server, a mobile terminal transmits its location information to the server, and the server uses the location information received from the mobile terminal to confirm whether the mobile terminal is located within a radius from a location in an area specified by the location information from the terminal, and then transmits the message received from the terminal to the mobile terminal, whereby unspecified recipients in an arbitrary area can be received a message, such as a short message service (SMS) message.

### BRIEF DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a configuration of a location-based message transmission and reception system according to an exemplary embodiment of the invention.

FIG. 2 is a flowchart depicting a location-based message transmission and reception method according to an exemplary embodiment of the invention.

### MODE FOR THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

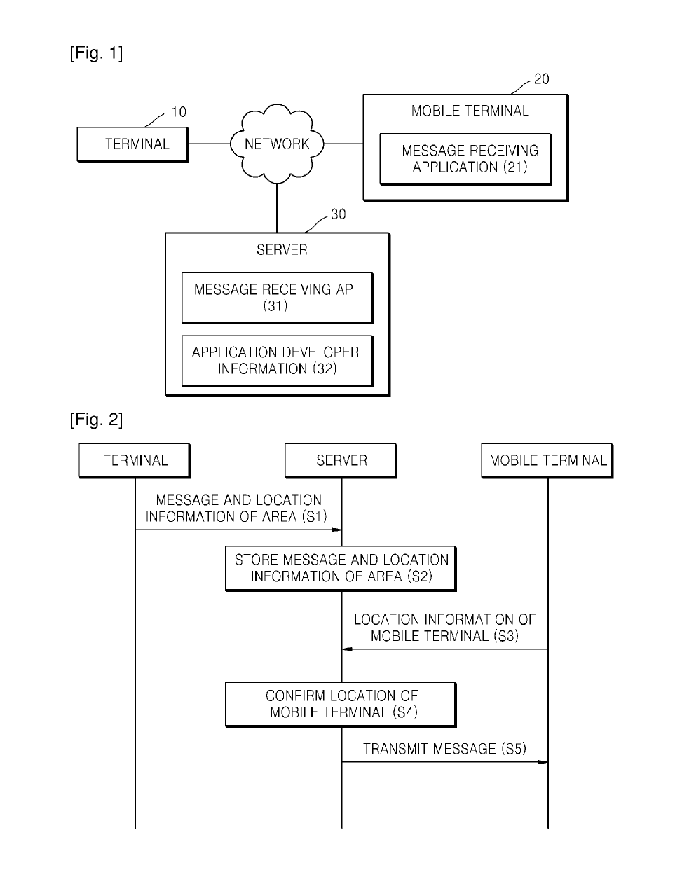

FIG. 1 is a block diagram of a configuration of a location-based message transmission and reception system according to an exemplary embodiment of the invention.

As shown in FIG. 1, location-based message transmission and reception system may include a terminal 10, a mobile terminal 20, and a server 30.

The terminal 10 may transmit location information of a specific area and a message made by a user, for example, a short message service (SMS) message, to the server 30. The terminal 10 may be a wired terminal, such as a wired telephone, or a mobile terminal, such as a mobile phone or a smart phone. The terminal's user may search for an area where to send a message from a search window shown on a display of the terminal 10, and choose a desired area from the search result, thereby specifying the area where the message is to be sent.

The mobile terminal 20 may be equipped with a message receiving application 21 to receive a message sent to the specific area, and in response to the execution of the message receiving application 21, the mobile terminal 20 may transmit its location information to the server and responsively receive a message from the server 30 and display the received message on a display. A network connected with the terminal 10, the mobile terminal 20, and the server 30 may be a data network of a mobile communication network or a wireless Internet.

The server 30 may store the message received from the terminal 10 and location information of the specific area, and transmit the stored message to the mobile terminal 20 that enters into a predetermined radius from a location in the area specified by the location information from the terminal 10. That is, the server 30 may utilize the location information received from the mobile terminal 20 to confirm whether the mobile terminal 20 is placed within the predetermined radius of the specified area, and, if the mobile terminal 20 is present within the predetermined radius, transmit the message received from the terminal 10 to the mobile terminal 20.

In addition, the server 30 may charge a message transmission fee to the user according to a distance over which the message received from the terminal 10 is to be transmitted and valid time of the message. Consequently, an operator of the server 30 can earn profit.

Moreover, the server 30 may store a message receiving application programming interface (API) 31 that is generated from a message receiving application for receiving a message transmitted to a specified area. The message receiving API 31 may be provided to be executed in a plurality of applications running on the mobile terminal 20. In response to a mobile terminal executing an application equipped with the message receiving API 31, a message transmitted to the area where the mobile terminal is located may be output on a display of the mobile terminal. In this case, the server 30 may store developer information of the application equipped with the message receiving API 31. The operator of the server 30 may distribute the profit produced from the message transmission fee to the developer of the application equipped with the message receiving API, wherein the message transmission fee is charged according to the distance over which the message is transmitted and the valid time of the message.

FIG. 2 is a flowchart depicting a location-based message transmission and reception method according to an exemplary embodiment of the invention.

As shown in FIG. 2, a terminal transmits location information of a specified area and a message made by a user, for example, a short message service (SMS) message to a server (S1). In this case, the terminal may be a wired terminal, such as a wired telephone, or a mobile terminal, such as a mobile phone or a smart phone. The terminal's user may search for an area to send the message to from a search window shown on a display of the terminal, and choose an area from the search result to specify the area to which the message is to be sent.

A server stores the message and location information received from the terminal (S2). Then, in response to executing a message receiving application for receiving a message transmitted to a specified area, a mobile terminal transmits its location information to the server (S3).

Based on the location information received from the mobile terminal, the server determines whether the mobile terminal is located within a predetermined radius from a location in the area specified by the location information received from the terminal, and if the mobile terminal is located within the predetermined radius, transmits the message, which has been received from the terminal, to the mobile terminal (S4 and S5). The terminal, the mobile terminal, and the server may communicate with one another via a data network of a mobile communication network or a wireless Internet, such as WiFi.

In addition, the server may charge a message transmission fee to a user according to a distance over which the message received from the terminal is transmitted and valid time of the message. Accordingly, an operator of the server can earn profit.

Moreover, the server may store a message receiving API. The message receiving API may be provided to be executed in a plurality of applications running on a mobile terminal. Hence, in a case where an application equipped with the message receiving API is executed in a mobile terminal, a message sent to an area where the mobile terminal having the application equipped with the message receiving API is located is enabled to be output on a display of the mobile terminal. Further, the server may store developer information of the application equipped with the message receiving API. The operator of the server may distribute the profit generated from the message transmission fee to the developer of the application equipped with the message receiving API, wherein the message transmission fee is charged to the user according to the distance over which the message is transmitted and the valid time of the message.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A location-based message transmission and reception system comprising:
a terminal configured to transmit location information of a specified area and a message made by a user to a server;
a mobile terminal configured to include a message receiving application to receive a message transmitted to a specified area and to transmit its location information to the server in response to executing the message receiving application and output a message received from the server on a display; and
the server configured to store the message and location information of the specified area received from the terminal, to confirm, based on the location information received from the mobile terminal, whether the mobile terminal is located within a radius from a location in an area specified by the location information received from the terminal, and to transmit the message received from the terminal to the mobile terminal.

2. The location-based message transmission and reception system of claim 1, wherein the terminal, the mobile terminal, and the server communicate with one another via a data network of a mobile communication network or a wireless Internet.

3. The location-based message transmission and reception system of claim 1, wherein the server charges a message transmission fee to the user of the terminal according to a distance over which the message received from the terminal is transmitted and valid time of the message.

4. The location-based message transmission and reception system of claim 3, wherein the server stores a message receiving application programming interface (API) generated from the message receiving application.

5. The location-based message transmission and reception system of claim 4, wherein the message receiving API is provided to be executed in a plurality of applications running on the mobile terminal.

6. The location-based message transmission and reception system of claim 5, wherein the server further stores developer information of developers of the respective applications equipped with the message receiving API.

7. The location-based message transmission and reception system of claim 6, wherein the server distributes profit generated from the message transmission fee charged to the user of the terminal to the developers of the respective applications.

8. A location-based message transmission and reception method comprising:
transmitting, from a terminal, location information of a specified area and a message made by a user of the terminal to a server;
storing, at the server, the message and location information of the specified area received from the terminal;
executing, at a mobile terminal, a message receiving application to receive a message transmitted to a specified area and transmitting location information of the mobile terminal to the server;
confirming, at the server, based on the location information received from the mobile terminal, whether the mobile terminal is located within a radius from a location in an area specified by the location information received from the terminal, and transmitting the message received from the terminal to the mobile terminal; and
outputting, at the mobile terminal, the message received from the server on a display of the mobile terminal.

9. The location-based message transmission and reception method of claim 8, wherein the terminal, the mobile terminal, and the server communicate with one another via a data network of a mobile communication network or a wireless Internet.

10. The location-based message transmission and reception method of claim 8, further comprising:
charging, at the server, a message transmission fee to the user of the terminal according to a distance over which the message received from the terminal is transmitted and valid time of the message.

11. The location-based message transmission and reception method of claim 10, wherein the server stores a message receiving application programming interface (API) generated from the message receiving application.

12. The location-based message transmission and reception method of claim 11, wherein the message receiving API is provided to be executed in a plurality of applications running on the mobile terminal.

13. The location-based message transmission and reception method of claim 12, wherein the server further stores developer information of developers of the respective applications equipped with the message receiving API.

14. The location-based message transmission and reception method of claim 13, further comprising:
distributing, at the server, profit generated from the message transmission fee charged to the user of the terminal to the developers of the respective applications.

15. The location-based message transmission and reception system of claim 2, wherein the server charges a message transmission fee to the user of the terminal according to a distance over which the message received from the terminal is transmitted and valid time of the message.

16. The location-based message transmission and reception method of one of claim 9, further comprising:
charging, at the server, a message transmission fee to the user of the terminal according to a distance over which the message received from the terminal is transmitted and valid time of the message.
